(19) United States
(12) Patent Application Publication
(10) Pub. No.: US 2022/0206317 A1
(43) Pub. Date: Jun. 30, 2022

(54) MYOPIA CONTROL OPTICAL LENS AND MANUFACTURING METHOD THEREOF

(71) Applicant: Ventura Biotechnology (Shanghai) Co., Ltd., Shanghai (CN)

(72) Inventor: JEOU-DER SUNG, SHANGHAI (CN)

(21) Appl. No.: 17/138,736

(22) Filed: Dec. 30, 2020

(51) Int. Cl. G02C 7/02

(52) U.S. Cl. CPC G02C 7/022; G02C 2202/20; G02C 2202/24; G02C 7/027

(57) ABSTRACT

The invention discloses a myopia control optical lens and a manufacturing method, relating to the technical field of optical lenses. Based on a diffraction grating written on or in kinoform diffraction and multifractal Fresnel zone plate lenses according to a profile in a map of radial refractive power of corneal topography, the diffraction grating determines the intensity of peripheral light guided to the periphery of retina, to achieve the purposes of optimal myopia defocusing. Long and short distance vision are enhanced, the current problems of different designs of frame glasses, multifocal and defocused myopia control are solved, the blurred and instable vision at different distances is controlled, and the myopia aggravation is prevented. The invention allows people to drive, watch and read under bright lighting conditions, and when reading is not needed in a dark environment, the invention allows people to drive and watch dashboards more clearly, and can prevent myopia aggravation.

### TECHNICAL FIELD

The present invention relates to the technical field of optical lenses, and in particular, to a myopia control optical lens and a manufacturing method thereof.

### BACKGROUD

At present, there are bifocal, multifocal, defocus and other frame glasses products used to control myopia in the market. However, after many years of clinical verification, it is found that the effect of myopia control is not good. The main reason is that it is difficult to keep the visual axis and the optical axis constant, and it is also difficult to calculate and master different aberrations caused by off-axis when they are changed.

Although the optical theory of multifocal contact lenses (MFCLs) is similar to that of Ortho-K lenses, it has not been confirmed that the myopic shift of peripheral refraction of the MFCL is similar to the diopter of the Ortho-K lens. Moreover, due to the material and manufacturing process precision and customized design characteristics of MFCLs, more research and development is needed for early clinical demonstration. In addition, blurred vision at different distances is also a problem to be overcome.

Ortho-k-related corneal shape changes form hyperopia defocus on the periphery of retina, which also increases eye aberration. Its imaging position and intensity are very important to the relative optical design in myopia control effectiveness. When the peripheral aberration appears around the retina, the imaging capability for distinguishing small objects will seriously decrease with the eccentricity. This may be mainly caused by optical and nerve distribution factors: an eccentricity angle causes optical aberration, so that the contrast of retina images is reduced, and the density of cone cells and ganglion cells also decreases with the frequency, thereby leading to sparse sampling of the optic nerve. Although in central vision, the optics of eyes (such as ametropia) may be the main limiting factor, in peripheral vision, the decrease of the nerve space function is the main limiting factor. Except the central fovea, the main optical degradation of retina around it is caused by oblique astigmatism and field curvature.

### SUMMARY

In view of this problem in practical application, the purpose of the present invention is to provide a myopia control optical lens and a manufacturing method thereof, with the specific solutions as follows:

a myopia control optical lens and manufacturing method thereof, where the method includes the following processing steps:

step 1: acquiring postoperative corneal aberration and radial refraction data of a patient after orthokeratology;

step 2: establishing a generalized binary Fresnel zone plate by using the postoperative corneal aberration and radial refraction data acquired in step 1, establishing an ideal profile of a kinoform high-efficiency diffraction lens by using an ideal continuous phase shift curve with the same approximate value of the generalized binary Fresnel zone plate, and creating a stepwise function for each region in the profile;

step 3: performing a multifractal zone plate design by using the postoperative corneal aberration, the radial refraction data and the stepwise function for each region in the profile of the kinoform high-efficiency diffraction lens in step 1 and step 2; and

step 4: coarsening the multifractal Fresnel zone plate designed in step 3 into a pinhole to build a photon sieve, the optical path length from a light source through the center of the pinhole to the focus being an integer multiple of the wavelength.

Further, in step 2, the efficiency ηm of the generalized binary Fresnel zone plate is: ηm=A²/C², A is the observed amplitude, and C is the intensity of an incident field.

Further, in step 2, the efficiency ηm of the generalized binary Fresnel zone plate is: ηm=A²/C², A is the observed amplitude, and C is the intensity of an incident field.

Further, in step 2, the efficiency ηm of the generalized binary Fresnel zone plate is: ηm=2[1−cos(2 πm/L)](L/m)², L is the diffraction efficiency calculated under different step profiles, and the diffraction efficiency is determined by the ratio of the power of the diffracted beam to the incident power of the beam.

Further, in step 3, the multifractal zone plate design is performed based on a triple Cantor set: M={S1, S2}, where S2=S1−1, the main focal length of a central Fresnel zone plate (FZP) is f=a²/λ3^{S1}, and the third order focal length of FZP can be given by the same expression.

Further, in step 4, the optical path length from a light source through the center of the pinhole to the focus being an integer multiple of the wavelength is expressed by formula rₙ²+p²+rₙ²+q²=p+q+nλ, where p is the distance between the light source and the photon sieve, q is the distance between the photon sieve and the focus, and r is the distance between the centers of light spots.

Compared with the prior art, the present invention has the following beneficial effects:

(1) The whole thickness of the lens is thinned, which can effectively improve the oxygen transmission rate of the lens when the lens is applied to a contact lens, thereby avoiding dry eye and ensuring a healthy and comfortable state of the cornea.

(2) The photon sieve according to the present invention has no connecting region, requiring no supporting member in manufacturing.

(3) The optical characteristics can be adjusted by designing and establishing the profile of the multifractal Fresnel zone plate and adjusting the sizes and distribution mode of pinholes of the photon sieve. According to the present invention, the profile of the Fresnel zone plate can be integrated into the photon sieve only by modifying the number, sizes and distribution mode of the pinholes in each region of the photon sieve.

### BRIEF DESCRIPTION OF THE DRAWINGS

FIG. 1.1 is a diagram of a diffraction system of light in a slit (mainly refraction);

FIG. 1.2 is a diagram of a diffraction system of light in a slit;

FIG. 1.3 is a diagram of a diffraction system of light in a slit (mainly diffraction);

FIG. 2 shows the diffraction of a plane wavefront with Gaussian intensity distribution at a slit;

FIG. 3 is a schematic diagram of a Fresnel zone plate supported by dividing a conventional lens into three horizontal portions;

FIG. 4 is a schematic diagram of a kinoform profile in a parabolic shape, with all waves from each region reaching P value in phase;

FIG. 5 is a schematic diagram of the Rayleigh criterion;

FIG. 6 is a diagram of refractive power in the corneal topography direction;

FIG. 7 is a schematic diagram of a fractal triple Cantor set;

FIG. 8 shows an example of multifractal zone plates (MFZPs) with M={3, 2};

FIG. 9 shows an equivalent CZP with the same focal length and resolution;

FIG. 10 is a schematic diagram of point-to-point imaging by a photon sieve;

FIG. 11 is a front sectional view of a kinoform high-efficiency diffraction lens; and

FIG. 12 is a front sectional view of an optical lens with a multifractal zone plate and a photon sieve.

### DESCRIPTION OF THE EMBODIMENTS

The present invention will be further described in detail below with reference to embodiments and accompanying drawings, but embodiments of the present invention are not limited thereto.

Wavefront aberration is a function to characterize the imaging characteristics of any optical system, which is defined as the difference between the ideal sphere and the actual wavefront at each point above the pupil. Example: Eyes without aberration have constant or zero aberration and form an ideal retinal image of a point source; and eyes with aberration generate more extensive, usually asymmetric retinal images. The imaging image of the point source is called a point spread function (PSF). Although wavefront aberration may be a very complex two-dimensional function, it can be decomposed by polynomial as the sum of pure aberration modes.

From PSF, the useful single image imaging quality parameter Strehl ratio is defined as the ratio of the peak intensity of eye PSF to the peak intensity of aberration-free (diffraction limit) PSF. In addition, by calculation of PSF of objects and eyes, retinal images of any scene can be predicted.

There are many factors causing degradation of retinal images, such as the diffraction of light in the pupil, optical aberration and intraocular scattering. Due to the wave characteristics of light, diffraction forms an image by an instrument smaller than the aperture limit. The diffraction effect in eyes generally has a very small impact, which is actually only obvious in small pupils. For the larger average pupil diameter of most people, the influence of eye aberration on the quality of retinal images is more significant.

Light wave has diffraction property, but diffraction is not always dominant. Like the aforementioned eye optical system, assuming that the lens has no aberration, a light spot with a minimum size obtained on the focal plane is called a diffraction limit light spot, because it is impossible to focus the light to a light spot smaller than the diffraction limit by using a conventional method. Since the refraction generates light spots at the edge of the lens, image parameters of a refractive lens are calculated according to the geometric law rather than the diffraction principle, because most of incident light is refracted, while only a small part of the input light is diffracted. The same is true when the size of the slit is much greater than the incident wavelength. When the slit opening is large, it is a system where refraction is dominant, while when the slit opening is small, it is a refractive system.

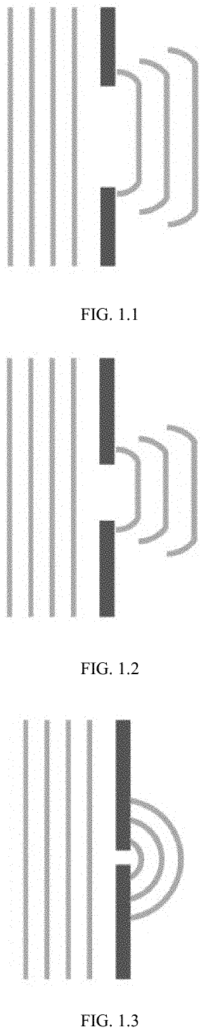

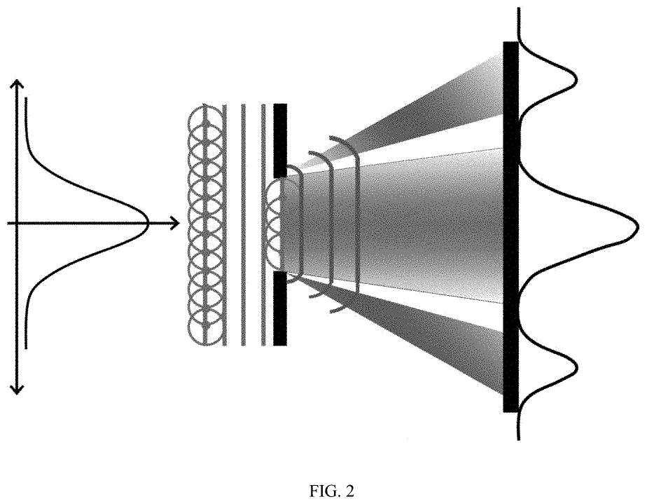

The system with different control of refraction and diffraction dominant is shown in FIG. 1.1, FIG. 1.2 and FIG. 1.3. Diffraction of light in slits with different widths: As shown in FIG. 1.1, FIG. 1.2 and FIG. 1.3, the slit widths decrease in sequence, indicating that the dominant role of diffraction increases. FIG. 1.1 shows a system where refraction is dominant, and FIG. 1.3 shows a system where diffraction is dominant. Secondary wavefront, primary wavefront, and plane wavefront with input intensity distribution are as shown in FIG. 2, and diffraction of plane wavefront with Gaussian intensity distribution is provided at a single slit aperture. However, when a part of the wavefront is blocked by the slit, the wavefront will bend at the edge. In refraction, light can be regarded as propagating in a straight line in a medium with a constant refractive index. Snell's law is applicable to interfaces (surfaces with varying refractive indices) and can be used to determine new directions. Usually, a refractive element is composed of a single unit, and its shape and refractive index determine its imaging characteristics. Unlike the refractive element, a diffractive element is composed of many different regions. A final image is a coherent superposition of light diffracted from each region. Every point at the hole has an influence on the intensity of one position of the output. Certainly, refraction also occurs, so the final behavior will be a combination of two kinds of influences.

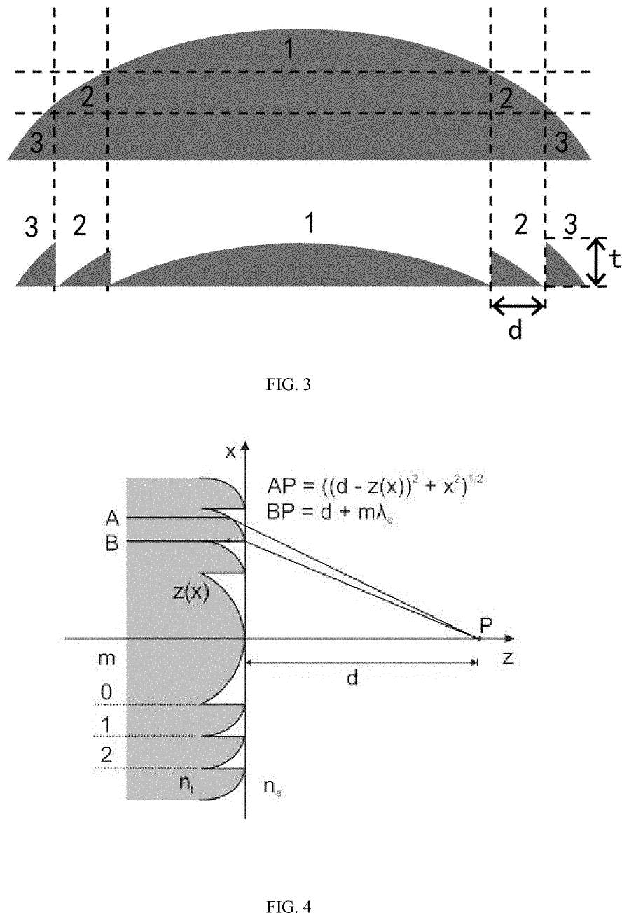

As shown in FIG. 3, an upper portion is a conventional lens, and a lower portion is a Fresnel zone plate. The Fresnel zone plate is made by dividing the conventional lens into three horizontal portions, and their performance is almost similar to that of the conventional lens except the additional diffraction effect. It is important that the Fresnel zone plate is still a refractive optical element, and its dimensions t and d are much greater than the wavelength of incident light.

The conventional Fresnel zone plate is composed of alternating transparent and opaque rings with the same area, so the transmittance of the Fresnel zone plate is periodic along the square of radial coordinates. The spatial resolution that these devices can achieve is about the width of the outermost region, so it is limited by the smallest structure manufactured. Because of its low efficiency and multifocal characteristics, the Fresnel zone plate is usually not used as an imaging system.

In order to optimize the imaging characteristics and improve the resolution of the Fresnel zone plate, a zone plate kinoform high-efficiency diffraction lens with high focusing efficiency at only one or two focuses and low efficiency at other focuses is studied in the present invention. The resolution can be improved and focusing energy can be increased. Like other optical imaging devices, the zone plate can also be described by using a mathematical function called a transmission function. The transmission function describes how the incident light changes (amplitude and phase) when it passes through a device. As shown in FIG. 4, a kinoform profile in a parabolic shape, with all waves from each region reaching P in phase, and thus the required phase modulation is introduced at each regional plate point. Specifically, all rays entering a region follow the same optical path length until they reach point P. The main characteristics of the kinoform zone plate are to introduce gradual phase shift of radian in the region, which can be implemented by changing the thickness of the zone plate portion.

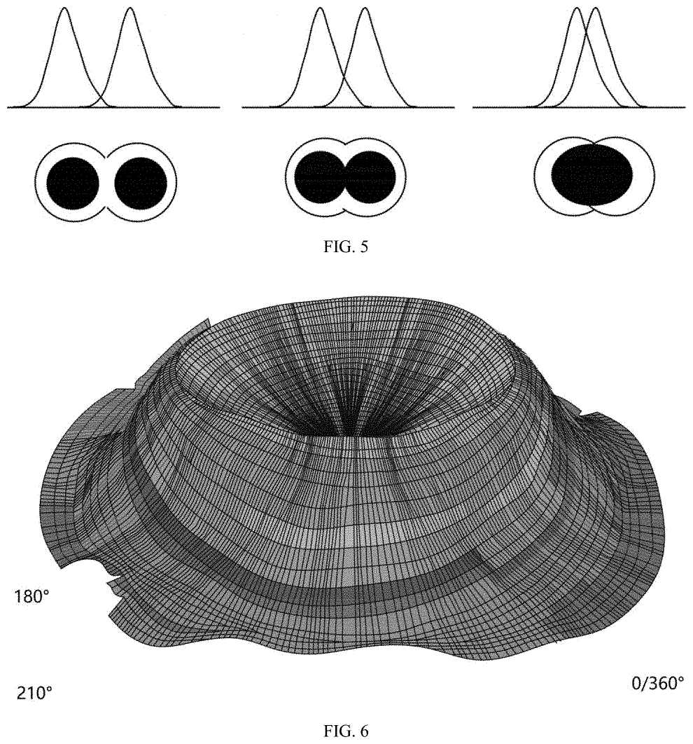

The resolution of an image system and a zone plate is generally the minimum distance between two distinguishable objects. Considering that two equally distant point sources pass through one aperture of the optical system, Airy patterns formed by the two point sources either overlap or are clearly distinguished. As shown in FIG. 5, the degree of pattern overlap can be applied as two resolution limits, which is the Rayleigh criterion.

When a central image of one Airy disk falls on the first minimum of the Airy disk of another point image, the Rayleigh criterion will be applied. The spatial resolution δm based on the Rayleigh criterion can be written as: δm=1.22 f λ/D (f is the focal length, 2 is the wavelength of light, and D is the diameter).

The resolution of an FZP is controlled by the width of the outermost region. The optical resolution of the zone plate can be written as δm=1.2ΔrN/m (N is the outermost region index, ΔrN is the width of the outermost region, and m is the diffraction order).

The photon sieve is another diffractive optical element, which is specially developed for focusing and imaging soft X-rays with high resolution. The photon sieve is essentially an FZP, in which a transparent zone is a square with radial coordinates. When illuminated by parallel wavefront, the FZP will generate multiple focuses, whose main lobe coincides with the lobe of the related conventional zone plate, but the internal structure of each focus presents a characteristic fractal structure, so that the self-similarity of the original FZP reappears. The photon sieve is a device that focuses light by diffraction and interference using a pinhole array, and minimizes the diffraction effect of micropores by reducing the diameter of the micropores and randomly distributing them on the disk. Another advantage of the photon sieve is that its optical characteristics can be adjusted by changing the sizes and distribution mode of pinholes, which indicates that devices based on the photon sieve concept can be customized according to various specific applications.

As shown in FIG. 6, corneal topography data characterized by corneal shape changes after Ortho-k operation is collected and converted into a map of aberration and radial refractive power. The region is surrounded by a peripheral region, and the peripheral region is further surrounded by an edge region and the concave surface, and the central optical region contains an inner disc and a plurality of valve rings. It is described by subtracting the aberrations and refractive changes of the eyes after orthokeratology from the refractive power before orthokeratology.

A generalized binary Fresnel zone plate is established according to a map of radial refractive power after an Ortho-k operation and the required wavefront aberration, then an ideal profile of the kinoform high-efficiency diffraction lens is constructed by using the ideal continuous phase shift curve with the same approximate value, and a stepwise function is created for each region in the profile.

The efficiency ηm of the FZP (which is “diffraction order of m^{th}”) is expressed by the formula: ηm=A²/C² (A is the observed amplitude, and C is the intensity of the incident field).

The formula can be further expressed as: ηm=2[1−cos (2 [symbol] /L)](L/m)² (L is the number of profile steps, the diffraction efficiency calculated under different step profiles is shown in the following table, and the diffraction efficiency is determined by the ratio of the power of the diffracted beam to the incident power of the beam).

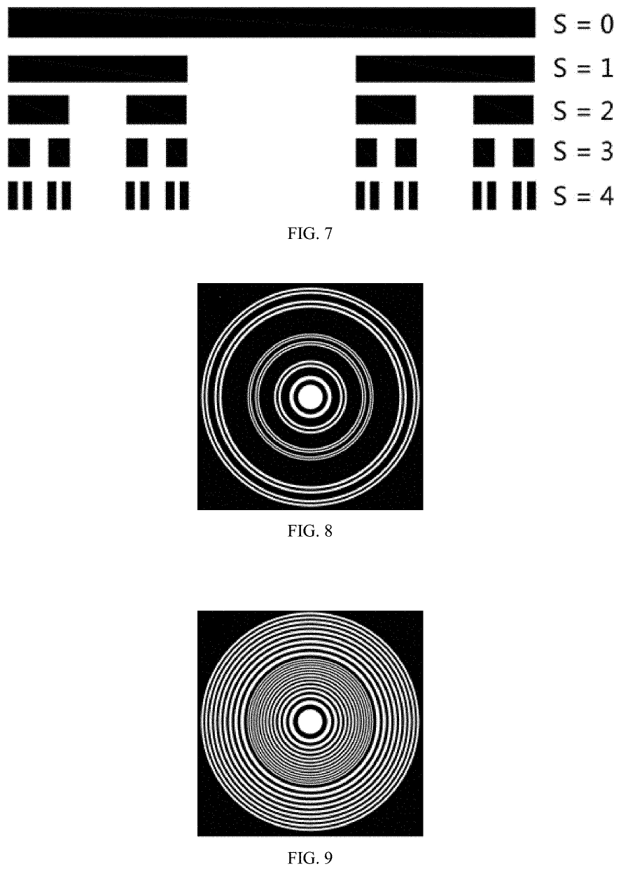

As shown in FIG. 7, the design of the MFZPs must be based on the fractal triple Cantor set shown in the upper portion of FIG. 7. The first step of the construction process includes defining a straight-line segment of unit length, which is called an initializer (stage S=0). Next, at stage S=1, subsequent generators of the set are constructed by dividing the segment into three equal parts with a length of ⅓ and removing the central part. This process is followed in the subsequent stages S=2, 3, . . . . Generally, in stage S, there are 2S segments (each segment has a length of 3−S) separated by 2S−1 gaps. The Cantor set set in the setting stage S is composed of two repetitions of the previous S−1, with a scale of ⅓ and located at both ends. For example, Cantor set S=4 presents two scaled repetitions of set S=3. Summary: The Cantor set multifractal with “multi-order” M={S1, S2} is defined as the synthesis of two different order S fractals, and S2 is scaled to ⅓, which is located in the first and third part of the fractal structure. In this way, the conventional fraction S=4 can be regarded as fractal compound M={3, 3}. Assuming that the multifractal of the Cantor set can be expressed mathematically by the one-dimensional binary function q (δ) defined in the interval [0,1], by changing the coordinate s=(r/a)² and through a one-dimensional function after rotation around an extreme, a zone plate with the measure coordinate r and an outermost ring with a radius of a is formed.

FIG. 8 shows an example of MFZPs with M={3, 2}, and FIG. 9 shows an equivalent CZP with the same focal length and resolution. To improve the resolution of the lens, MFZPs are considered, M={S1, S2}, where S2=S1−1. MFZPs are constructed, the main focal length of the central FZP is f=a2/λ3S¹, and the third order focal length of the FZP can be given by the same expression. Through this configuration, the smaller region of the outer FZP can be greater than the smaller region of the central FZP by 73.2%.

By analysis of the structural constraints of the FZP and the relationship between different parameters, it is shown that lacunarity has a significant influence on the axial irradiance provided by different FZPs with the same fractal dimension, but the basic aspects are self-similar. Variable lacunarity is related to axial irradiance given by the FZP and different focuses, and has fractal properties. Through different settings of lacunarity parameters, the initial position of a diffraction grating and the retinal image quality and resolution can be optimized by adjusting the intensity of different focuses.

The secondary maximum has always been a disadvantage of the FZP. As mentioned above, the Airy pattern is observed from a diffracted circular hole. When light passes through a circular aperture, the intensity will be attenuated as predicted by a first Bessel function, and in the aperture, the transmittance suddenly becomes zero at the edge of the aperture. For the FZP, the amplitude contribution of each ring is equal at the focus. When the contribution suddenly exceeds the outermost ring and drops to zero, the oscillation of light intensity will occur.

Secondary maxima are caused by the diffraction of many concentric circular regions of the FZP, and correspond to the first, second and higher order bright rings collected in the Airy pattern mode. The secondary maximum will cause image blur. It also increases the background noise level and reduces the contrast of the image. In addition, the resolution of the FZP is controlled by the width of the outermost region. There may be processing limitations when a high-resolution zone plate is approached. The photon sieve provides an opportunity to suppress the secondary maximum of the FZP, which can make the image focused more clearly, and also overcomes the technological limitation of FZP resolution.

Then MFZPs are coarsened into pinholes to create a photon sieve which is easy to manufacture. The concept of the photon sieve is similar to that of the FZP, and the positions of pinholes must be correct to meet the standard of constructive interference. This requires that the optical path length (OPL) from a light source through the center of the pinhole to the focus must be an integer multiple of the wavelength. The standard can be expressed as the following formula: rₙ²+p²+rₙ²+q²=p+q+n (p is the distance between light source and the photon sieve, q is the distance between the photon sieve and the focus, and r is the distance between the centers of light spots). FIG. 10 shows the relationship between holes, a light source, a photon sieve and a focal plane, and is a schematic diagram of point-to-point imaging by the photon sieve.

Compared with the FZP, the photon sieve has many advantages. However, the lower transmittance is a very critical limitation of the photon sieve. The transmittance of the amplitude zone plate is usually 50%, while the transmittance of the photon sieve is only 15% to 20%. The difference between the transmittance of the FZP and the transmittance of the photon sieve is proportional to the opening area of the zone and the pinholes. The low transmittance does not prevent the application of the photon sieve using a high-intensity light source, such as a synchrotron for an X-ray microscope. For common applications with low light source intensity, low transmittance may limit the application of the photon sieve. Low transmittance reduces the signal strength and the contrast between signals and the background, resulting in poor image quality. The contrast of an image is defined as:

Contrast=(Imax−Imin)/(Imax+Imin)

where Imax and Imin are the maximum and minimum intensities of the image, respectively.

The photon sieve is composed of coated transparent substrate, and an opaque coating with pinholes is used. Light can pass through these holes and diffract to form an image. In this embodiment, the transparent substrate is quartz. The anti-reflection coatings on both sides of the glass substrate can only improve the transmittance of the photon sieve by about 8% (4% for each side) at most. In the phase-shifted photon sieve, the whole photon sieve is transparent to the light source, and the pinhole has a phase shift of t relative to other photon sieves, so the transmittance can be significantly improved.

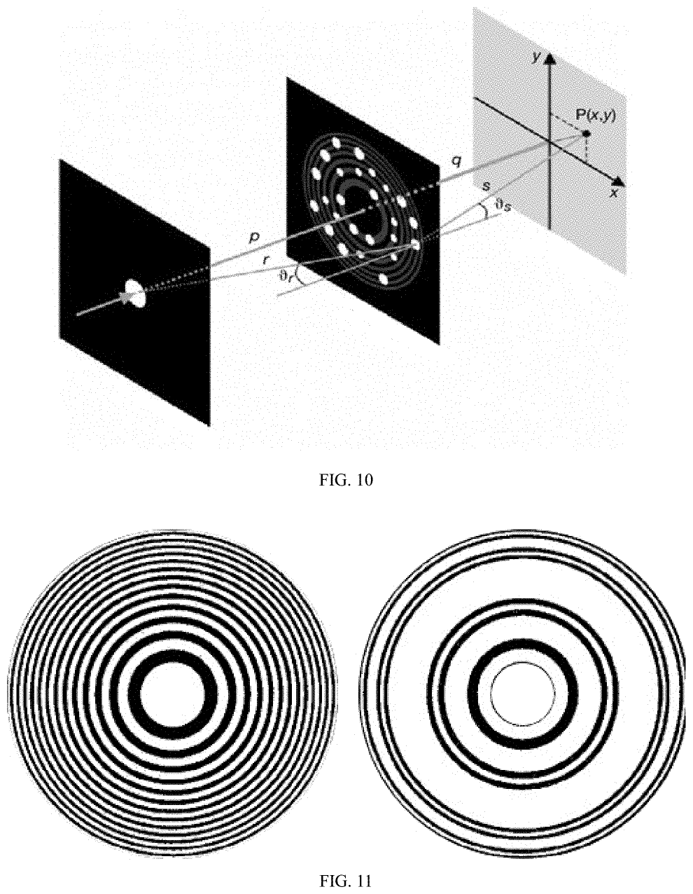

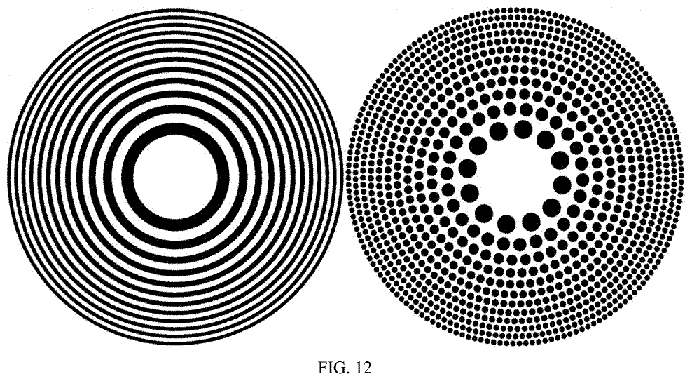

As shown in FIG. 11 and FIG. 12, the present invention specifically includes a diffraction grating written into a kinoform high-efficiency diffraction or multifractal Fresnel zone plate lens. Light energy passing through the diffraction lens is usually concentrated to one, two or higher diffraction orders. With regard to diffraction correction lenses, the high diffraction efficiency of zero order means that the visibility at a long distance has been greatly improved. The diffraction efficiency of the first order or the second order or above can be oriented according to the design of the defocus position, and the light energy of each diffraction order is determined by the fractal step height. Ambient light from the ambient light source is diffracted by the diffraction grating, so that it appears at the same position as the ambient light roughly in the direction of the central field of view. Peripheral light and light from the surrounding scene at least partially overlap each other. Based on a diffraction grating written on or in kinoform high-efficiency diffraction and multifractal Fresnel zone plate lenses according to a profile in a map (FIG. 6) of radial refractive power of corneal topography, the diffraction grating efficiency determines the intensity of peripheral light guided to the periphery of retina, so as to achieve the purposes of optimal myopia defocusing and increasing corneal positive spherical aberration. As a result, long-distance vision and short-distance vision are enhanced at the same time. The current common problems of different designs of frame glasses and soft and hard contact lenses for bifocal, multifocal and defocused myopia control are solved, the blurred and instable vision at different distances is controlled, and the myopia aggravation is effectively prevented. In vision in daily life, the present invention allows a person to drive, watch a computer monitor and read under bright lighting conditions, and when reading is not needed in a dark environment, the present invention allows the person to drive and watch a dashboard more clearly, and can effectively prevent myopia aggravation.

As shown in FIG. 3, due to the optical device FZP characteristics of the Fresnel zone plate of the manufactured multifractal Fresnel zone plate for defocus myopia control, the whole lens thickness becomes small. Especially, if it is applied to contact lenses, it can greatly increase the oxygen permeability (Dk/t) of the lenses and greatly improve the long-term health and comfort of cornea.

Besides, the photon sieve diffraction based on the conventional FZP is disclosed, and the interference technology is applied thereto. Unlike the FZP, the photon sieve has no connecting region, and the surface requiring no supporting rod can be manufactured. In addition, only by modifying the number of holes in each region, the FZP profile can be easily integrated into the photon sieve. The photon sieve is essentially an FZP, where a ring is decomposed into independent circular holes. Another advantage of the photon sieve is that its optical characteristics can be adjusted by changing the sizes and distribution mode of pinholes, which indicates that devices based on the photon sieve concept can be customized according to various specific applications and are easy to manufacture. This meets the requirements of myopia control for personalized aberration and defocus correction.

The above described are only preferred implementations of the present invention, and the protection scope of the present invention is not limited to the above embodiments. All technical solutions that belong to the idea of the present invention fall within the protection scope of the present invention. It should be noted that those of ordinary skill in the art can make several improvements and modifications without departing from the principles of the present invention. These improvements and modifications should also be considered as falling within the protection scope of the present invention.

What is claimed is:

1. A myopia control optical lens and a manufacturing method thereof, wherein the method comprises the following processing steps:
step 1: acquiring postoperative corneal aberration and radial refraction data of a patient after orthokeratology;
step 2: establishing a generalized binary Fresnel zone plate by using the postoperative corneal aberration and radial refraction data acquired in step 1, establishing an ideal profile of a kinoform high-efficiency diffraction lens by using an ideal continuous phase shift curve with the same approximate value of the generalized binary Fresnel zone plate, and creating a stepwise function for each region in the profile;
step 3: performing a multifractal zone plate design by using the postoperative corneal aberration, the radial refraction data and the stepwise function for each region in the profile of the kinoform high-efficiency diffraction lens in step 1 and step 2; and
step 4: coarsening the multifractal Fresnel zone plate designed in step 3 into a pinhole to build a photon sieve, the optical path length from a light source through the center of the pinhole to the focus being an integer multiple of the wavelength.

2. The myopia control optical lens and the manufacturing method thereof according to claim 1, wherein in step 2, the efficiency ηm of the generalized binary Fresnel zone plate is: ηm=A²/C², A is the observed amplitude, and C is the intensity of an incident field.

3. The myopia control optical lens and the manufacturing method thereof according to claim 1, wherein in step 2, the efficiency ηm of the generalized binary Fresnel zone plate is: ηm=2[1−cos (2 πm/L)](L/m)², L is the diffraction efficiency calculated under different step profiles, and the diffraction efficiency is determined by the ratio of the power of the diffracted beam to the incident power of the beam.

4. The myopia control optical lens and the manufacturing method thereof according to claim 1, wherein in step 3, the multifractal zone plate design is performed based on a triple Cantor set: M={S1, S2}, wherein S2=S1−1, the main focal length of a central Fresnel zone plate (FZP) is f=a²/λ3^{S1}, and the third order focal length of FZP can be given by the same expression.

5. The myopia control optical lens and the manufacturing method thereof according to claim 1, wherein in step 4, the optical path length from a light source through the center of the pinhole to the focus being an integer multiple of the wavelength is expressed by formula rₙ²+p²+rₙ²+q²=p+q+nλ, wherein p is the distance between the light source and the photon sieve, q is the distance between the photon sieve and the focus, and r is the distance between the centers of light spots.
